(19) United States
(12) Patent Application Publication
(10) Pub. No.: US 2004/0035012 A1
(43) Pub. Date: Feb. 26, 2004

(54) Measuring device having symbols viewable in multiple orientations

(76) Inventors: Stephanie J. Moehnke, Forest Grove, OR (US); Franz M. Laska, Othello, WA (US); James D. Laska, Othello, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/354,696

(22) Filed: Jan. 29, 2003

Related U.S. Application Data
(60) Provisional application No. 60/406,186, filed on Aug. 26, 2002.

(51) Int. Cl. G01C 3/04

(52) U.S. Cl. 33/494

(57) ABSTRACT

A measuring device having symbols that are viewable in any one of multiple orientations. Also disclosed is a measuring device having multiple sets of markings, wherein any one of the multiple marking sets can be presented to the user.

### CLAIM OF PRIORITY

This application claims the benefit U.S. provisional application No. 60/406,186, entitled “Measuring Device With Adjustably Viewable Symbols,” filed on Aug. 26, 2002.

### FIELD OF THE INVENTION

The invention relates generally to measuring tools such as tape measures, rulers, and the like. More specifically, the invention relates to a measuring device having symbols that are viewable in multiple orientations.

### BACKGROUND OF THE INVENTION

Measuring devices, such as tape measures, rulers, and the like, find application in a variety of fields, including construction, the machining and manufacturing trades, science and research labs, as well as every-day home use. A typical measuring device comprises a tape or blade upon which a set of markings is formed or printed. The markings generally include graduation marks to denote distance (e.g., ⅛″, 1/16″, or 1/32″ graduations) and a plurality of numerals or other symbols to denote magnitude. A measuring device typically presents either English or Metric units (although usually not both).

A conventional tape measure is typically “left-hand read.” To measure with a left-hand read tape measure, the tape is hooked to the left and the tape measure pulled to the right (e.g., by the user's hand). When used in this manner, a left-hand read tape measure (or other left-hand read measuring device) will present the numbers right-side up to the user. However, when measuring from the opposite direction—i.e., hooking at the right and pulling the tape measure to the left—the numbers will appear upside down to the user. Less prevalent are “right-hand read” tape measures, wherein the numbers are presented right-side up when hooked at the right and pulled to the left. Again, however, when used in the opposite direction, the numerals are presented upside down to the user.

When using a left-hand read tape measure or other measuring device in the opposite direction, the numbers or other symbols will appear upside down to the user, as noted above. This upside down presentation of symbols to the user may be confusing to read, which can lead to measurement errors. To complicate matters further, in some applications such as construction framing, it is common to change the orientation of a tape measure many times and/or to measure over long distances. In such applications, presenting numbers in only a single orientation can make a measurement difficult to discern and may lead to errors and, at the very least, requires the user to exercise greater care, thereby slowing the pace of work.

To address the above-described problems, it is known to place two sets of numerals on a measuring device such as a tape measure—one set having an orientation 180 degrees apart from the other set. Often times, the numbers of one set are closely spaced next to numbers of the other set, and the numbers may appear cluttered to the user. Although helping to address the problems created by the upside down presentation of numbers, the simultaneous presentation of multiple sets of numerals to the user may cause confusion, lead to errors, and/or slow the pace of work.

Another limitation of conventional measuring devices is that they typically only present one set of markings. For example, a measuring device may include a set of markings corresponding to English units, and if the user desires to obtain a measurement in Metric units, a separate measuring device providing a Metric measurement system must be obtained. By way of further example, it may be desirable to present a specialized measuring system to the user (e.g., a set of markings tailored for roofing, drywalling, or framing, etc.). Once again, however, when the user wishes to take a measurement in other than the specialized measurement system (e.g., in standard English units), the user will need to obtain a separate measuring device. It may be possible to simultaneously present both an English and a Metric measurement system—or both a specialized and a standard measurement system—however, such a measuring device may be difficult to understand and read.

### SUMMARY OF THE INVENTION

In one embodiment, a measuring device comprises a base having a plurality of graduation marks disposed thereon. A number of symbols are also disposed on the base, and each of the symbols is alterable between a first orientation and a second orientation in response to relative movement of the base.

In another embodiment, a tape measure comprises a housing and a tape that can extended from and retracted into the housing. A plurality of symbols is disposed on the tape. When a portion of the tape is extended from the housing, the symbols on this extended portion of tape are alterable between a first orientation and a second orientation in response to relative movement of the extended portion of tape.

In a further embodiment, a measuring device comprises a base having a plurality of graduation marks disposed thereon. An emissive device is also disposed on the base. The emissive device provides a symbol, and the emissive device is switchable between a first state wherein the symbol is presented in a first orientation and a second state wherein the symbol is presented in a second orientation.

In yet another embodiment, a tape measure comprises a housing and a tape that can be extended and retracted from the housing. An emissive device is disposed on the tape. The emissive device provides a symbol, and the emissive device is switchable between a first state wherein the symbol is presented in a first orientation and a second state wherein the symbol is presented in a second orientation.

In yet a further embodiment, a measuring device comprises a base having a first set of markings and a second set of markings. The first set of markings includes a number of symbols, and the second set of markings includes a number of symbols. The measuring device is alterable between presentation of the first set of markings and presentation of the second set of markings.

### BRIEF DESCRIPTION OF THE DRAWINGS

FIGS. 1A and 1B are schematic diagrams illustrating an embodiment of a measuring device having symbols viewable in multiple orientations.

FIGS. 2A and 2B are schematic diagrams illustrating another embodiment of a measuring device having symbols viewable in multiple orientations.

FIGS. 3A and 3B are schematic diagrams illustrating a further embodiment of a measuring device having symbols viewable in multiple orientations.

FIGS. 4A through 4D are schematic diagrams illustrating an embodiment of operation of the measuring devices shown in FIGS. 1A through 3B.

FIGS. 5A through 5D are schematic diagrams illustrating another embodiment of operation of the measuring devices shown in FIGS. 1A through 3B.

FIGS. 6A and 6B are schematic diagrams illustrating an embodiment of a tape measure having symbols viewable in multiple orientations.

FIG. 7 is a schematic diagram illustrating embodiments of operation of the tape measure shown in FIGS. 6A and 6B.

FIGS. 8A and 8B are schematic diagrams illustrating another embodiment of a tape measure having symbols viewable in multiple orientations.

FIGS. 9A and 9B are schematic diagrams illustrating an embodiment of a measuring device having multiple sets of markings that are selectively viewable.

FIGS. 10A and 10B are schematic diagrams illustrating a conventional lenticular substrate.

### DETAILED DESCRIPTION OF THE INVENTION

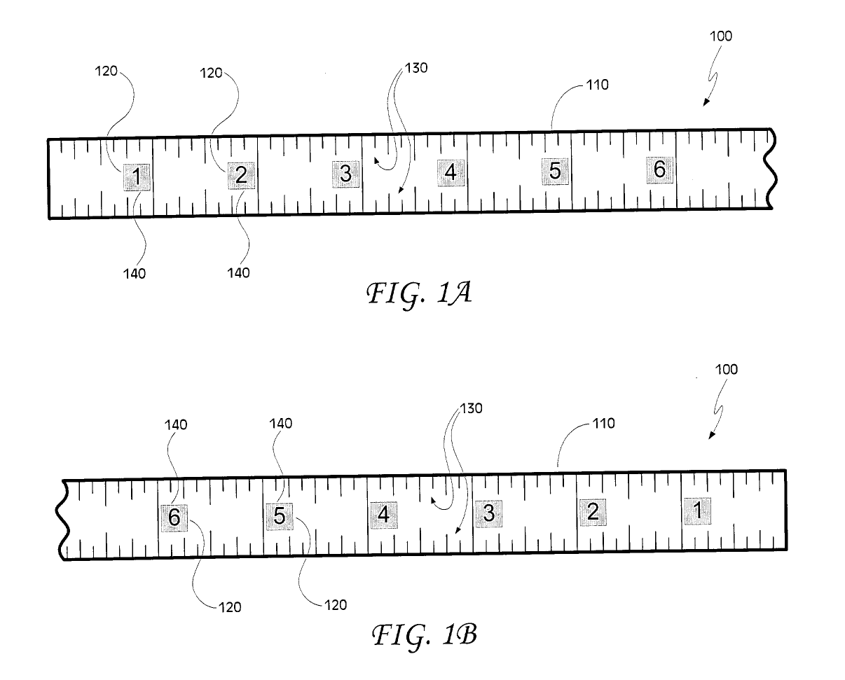

Referring to FIGS. 1A and 1B, illustrated is an embodiment of a measuring device 100 having symbols viewable in multiple orientations. The measuring device 100 includes a base 110, which may comprise a flexible tape (e.g., for a tape measure), a thin rectangular shaped bar (e.g., a blade for a ruler, straight edge, or other measuring stick), or other suitable structure. Note that only a portion of the base 110 is shown in each of FIGS. 1A and 1B. The base may be constructed of any suitable material, including, for example, metals, plastics, and composite materials.

Disposed on the base 110 are a number of symbols 120 (e.g., numbers), and each of the symbols 120 can be viewed in multiple orientations. For example, in FIG. 1A, the symbols 120 are right-side up when taking a measurement from the left (i.e., left-hand read), whereas in FIG. 1B, the symbols 120 are right-side up when taking a measurement from the right (i.e., right-hand read). Accordingly, for the embodiment shown in FIGS. 1A and 1B, the symbols 120 are viewable in two orientations, wherein these orientations are 180 degrees apart. Thus, the symbols 120 always appear right-side up to the user and, further, only one orientation is presented to the user at a time. As a result, conditions that may lead to measurement errors—e.g., symbols that are closely spaced and cluttered together, symbols that are presented upside down, etc.—are prevented.

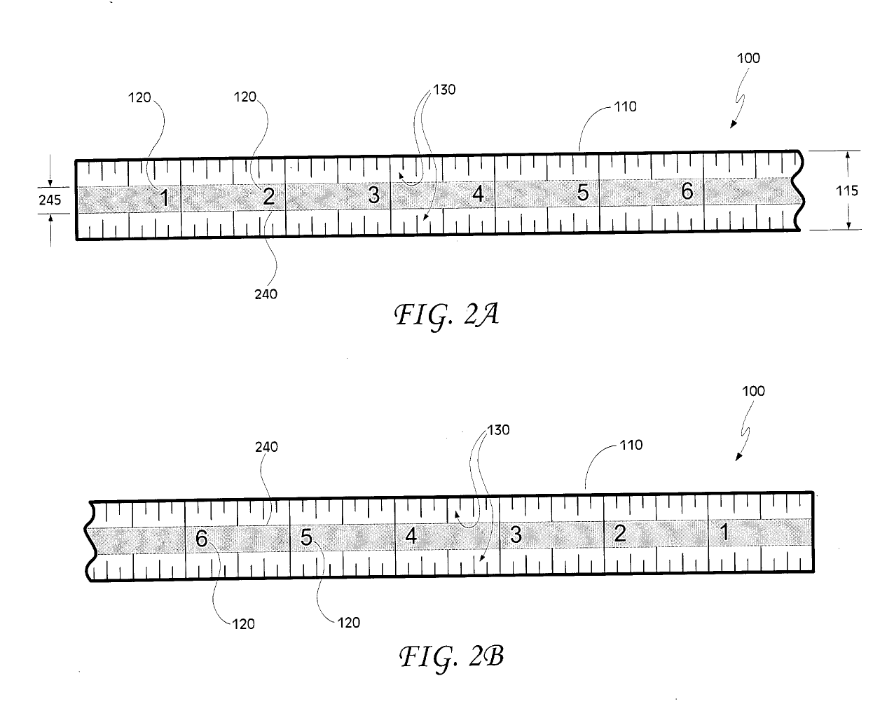

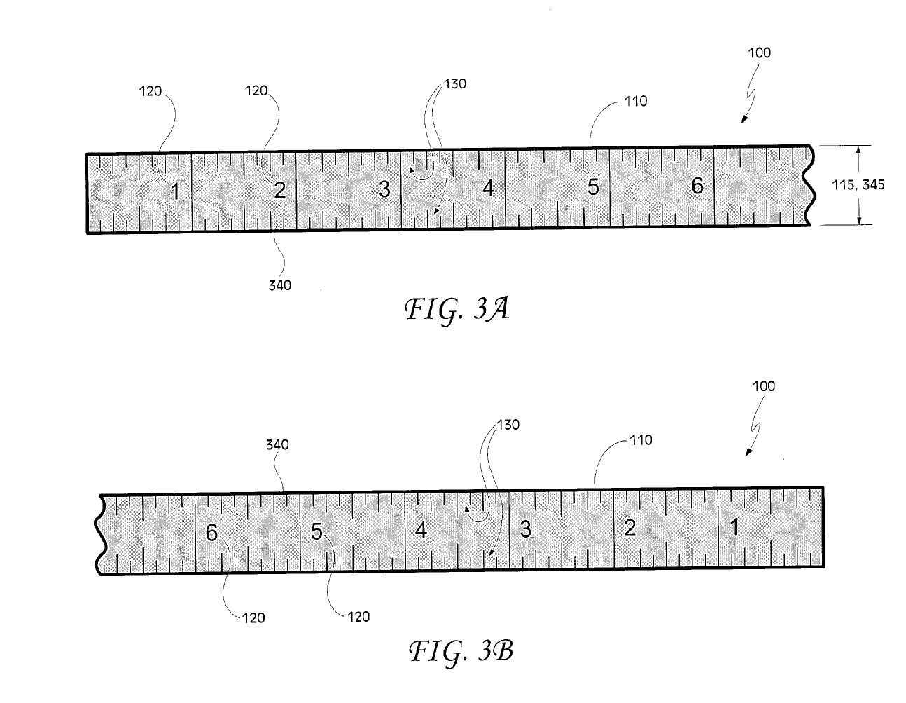

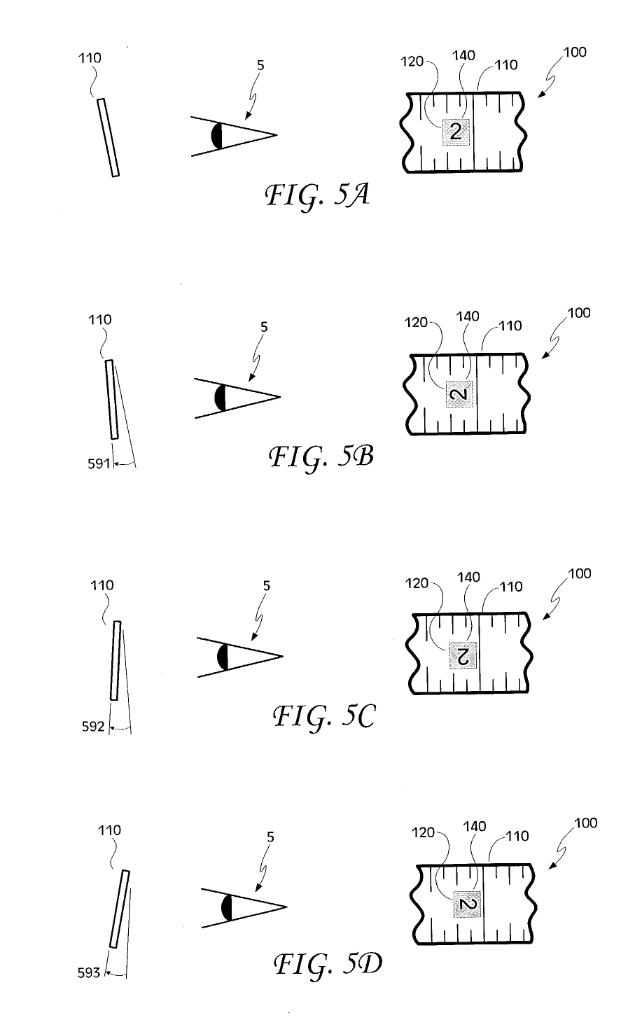

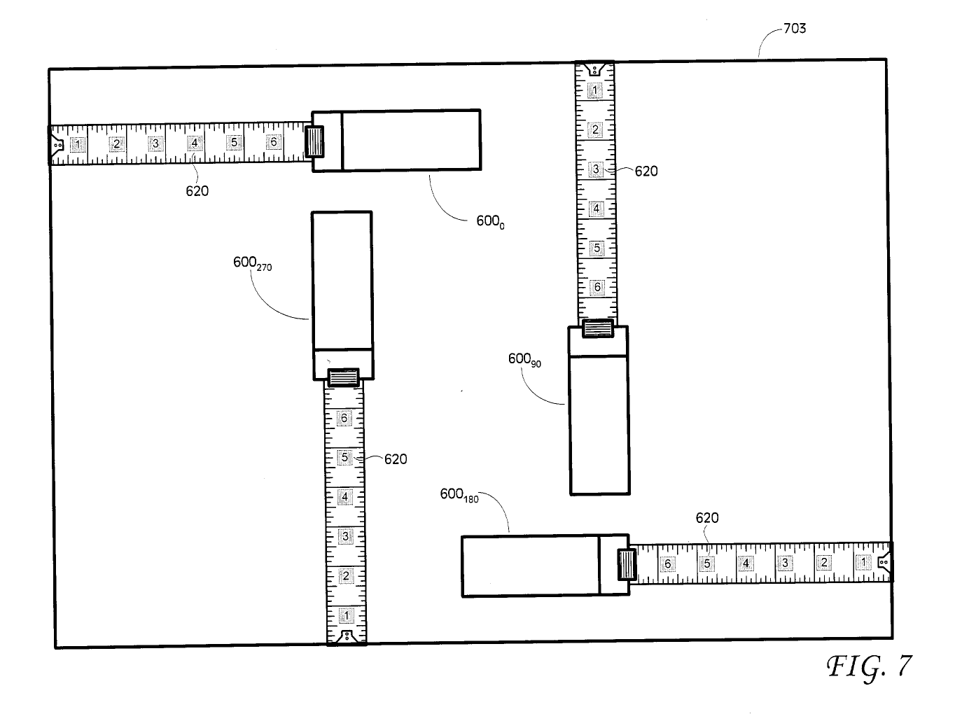

Although FIGS. 1A-B (as well as FIGS. 2A, 2B, 3A, and 3B, which are discussed below) illustrate only two orientations of the symbols 120, it should be understood that any desirable number of orientations may be provided. For example, the measuring device 100 may provide four separate orientations of the symbols 120, wherein the orientations are separated from one another by 90 degrees (such an embodiment is shown and described below with respect to FIGS. 5A-5D and FIG. 7). Further, although the symbols 120 comprise numbers in the embodiment shown in FIGS. 1A-B (as well as the other embodiments described herein), it should be understood that the disclosed embodiments are not limited to the use of numbers and that any suitable set of symbols may be employed.

Also disposed on the base 110 are a plurality of graduation marks 130. Any suitable set of graduation marks may be used for measuring device 100, including graduation marks corresponding to the English system, graduation marks corresponding to the Metric system, as well as graduation marks corresponding to a specialized measurement system (e.g., for roofing, framing, drywalling, etc.). Generally, each of the graduation marks 130 denotes a unit of distance. For example, in the English system, the graduation marks 130 may each denote ⅛″, 1/16″, 1/32″, or any other suitable length, whereas in the Metric system, the graduation marks 130 may each denote 1 mm, 1 cm, or other suitable length. The graduation marks may be formed using any suitable technique, including printing, etching, and stamping, as well as other methods. Also, in one embodiment that is to be described in greater detail below, the set of graduation marks itself may be presented in multiple orientations and/or multiple sets of graduation marks may be provided, wherein one orientation or one set of graduation marks can be selectively viewed by the user.

In the disclosed embodiments, the symbols 120 generally comprise numbers that indicate a magnitude of length. However, it should be understood that the symbols 120 are not limited to numbers, to the indication of a magnitude, or to the indication of length (e.g., a measuring device having symbols viewable in multiple orientations may comprise a device for obtaining angular measurements, wherein the symbols correspond to angles). Also, the symbols are not limited to whole numbers (e.g., 1, 2, 3, . . . ), as illustrated in the figures. For example, the symbols 120 may includes fractions (e.g., ¼, ½, etc.) or numbers expressed in decimal form (e.g., 0.5, 1.5, 2.5, etc.) that correspond with the graduation marks 130. Further, in addition to the uniformly increasing numbers shown in the figures, a measuring device 100 may include other symbols that correspond with the graduation marks 130. By way of example, for an English unit measuring device, the symbols 120 may include feet designations every twelve inches (e.g., 1 ft, 2 ft, 3 ft, . . . ), as well as inch markings within each linear foot (e.g., a second set of numbers running from 1 to 11 within each foot). A Metric unit measuring device may includes similar symbols. In addition, in yet another embodiment, a measuring device 100 may include some symbols 120 that are alterable between any one of multiple orientations, as well as other symbols that are permanent (e.g., always presented in the same orientation).

The symbols 120 may be provided by any suitable device and/or any suitable method or technology. By way of example, each of the symbols (or the set of symbols) may comprise or be provided by a lenticular device, a hologram, an emissive device, or any suitable combination thereof. Emissive devices that may find application in the disclosed embodiments include, for example, light emitting diodes (LEDs), organic light emitting diodes (OLEDs), electroluminescent displays, liquid crystal display (LCDs), and electrochromic displays. It should be understood, however, that the disclosed embodiments are not limited to the above-listed technologies and, further, that any suitable device or technique may be employed to provide the symbols 120 that are viewable in multiple orientations.

Generally, the desired orientation of the symbols 120 is presented in response to an input from the user. In one embodiment, the symbols 120 may alternate between two or more orientations in response to rotation or other movement of the base 110 (e.g., as may be the case for lenticular devices and holograms). In this embodiment, it should be understood that the base 110 may be stationary (e.g., held stationary by the user or rigidly affixed to another structure or surface) and the user's position or angle of viewing changed to alternate the symbols 120 between orientations. Of course, a change in the user's position or viewing angle in combination with movement of the base 110 may also be employed to alternate between orientations of the symbols 120. In another embodiment, the symbols 120 are alterable between orientations in response to an electrical signal input by the user (e.g., as may be used for emissive devices). For example, an electrical signal may be generated in response to the user depressing a button or toggling a switch. Such an electrical input signal may also be provided by other techniques that do not require the user to perform a hand/finger operation, such as in response to a voice command using voice recognition technology. The disclosed embodiments are, however, not limited to the utilization of a user input to alternate between orientations of the symbols and, in a further embodiment, switching between symbol orientations is performed automatically (e.g., using sensors to determine whether a left-hand read or a right-hand read measurement is being performed and orienting the symbols accordingly).

As shown in each of FIGS. 1A and 1B, each of the symbols 120 may comprise a separate device 140 that has be attached to the base 110 in the appropriate location. Each device 140 may comprise a lenticular device, a holographic device (e.g., a substrate upon which a hologram has been formed), or an emissive device, as summarized above. A device 140 may be attached using any suitable technique for securely coupling the device with the base 110, including adhesive bonding, welding, thermo-compression bonding, etc. Also, in a further embodiment, a device 140 (e.g., a lenticular device, a holographic device, or an emissive device such as an OLED) may be formed directly on the base 110. In other embodiments, as illustrated in FIGS. 2A-2B and FIGS. 3A-3B, a single device (rather than multiple devices) may provide all of the symbols. Also, in yet a further embodiment, the base 110 itself may comprise a device (e.g., a lenticular device, a holographic device, or an emissive device) that provides the symbols.

Turning now to FIGS. 2A and 2B, another embodiment of the measuring device 100 is illustrated. The embodiment of measuring device 100 shown in FIGS. 2A and 2B generally functions in a manner similar to that described above for the embodiment of measuring device 100 shown and described with respect to FIGS. 1A and 1B. However, in FIGS. 2A and 2B, all of the symbols (or at least two or more symbols) are provided by a single device 240 that is secured to the base 110. The device 240 may comprise a lenticular device, a holographic device, or an emissive device, as set forth above, and the device 240 may be attached to base 110 using any suitable technique, also as described above (e.g., adhesive bonding, welding, thermo-compression bonding, etc.). Note that in FIGS. 2A-2B, a width 245 of the device 240 is less than a width 115 of the base 110.

Referring to FIGS. 3A and 3B, a further embodiment of the measuring device 100 is shown. Again, all of the symbols 120 (or at least two or more symbols) are provided by a single device 340 that is secured to the base 110. The device 340 may comprise a lenticular device, a holographic device, or an emissive device, and the device 340 may be attached to base 110 using any suitable technique, as previously described.

The embodiment of measuring device 100 shown in FIGS. 3A and 3B generally functions in a manner similar to that described above for the embodiment of measuring device 100 shown and described with respect to FIGS. 1A and 1B. However, for the embodiment of FIGS. 3A and 3B, a width 345 of the device 340 is substantially the same as the width 115 of base 110. In the embodiment shown in FIGS. 3A-3B, the graduation marks 130 may be provided by, or formed directly on, the device 345. Thus, in addition to providing multiple orientations of symbols 120, various orientations and/or differing sets of graduation marks 130 may be provided and selectively presented to the user in response to an input (or presented automatically). Of course, it should be understood that, for the embodiment of FIGS. 3A-3B, the graduation marks 130 may still be formed or printed on the base 110 and simply viewed through the device 340 (e.g., a lenticular material may be transparent, which would enable graduation marks 130 to be seen through the lenticular).

In yet another embodiment, as mentioned above, the base 110 itself may comprise a device capable of providing the symbol 120 viewable in multiple orientations. For example, the base 110 may comprise a lenticular device, a substrate upon which holographic images have been created, or an emissive device (e.g., an LED, an OLED, an electroluminescent display, an LCD, or an electrochromic display). This device would provide both the symbols 120 and the graduation marks 130. Again, in addition to providing multiple orientations of symbols 120, various orientations and/or differing sets of graduation marks 130 may be provided.

Although the disclosed embodiments are presented in the figures in black and white, it should be understood that color may be used to enhance the measuring devices disclosed herein. For example, where the devices 140, 240, 340 comprise lenticular devices disposed on an underlying base 110, color effects—such as, for example, color matching or color texturing—between the color of base 110 and the color of symbols 120 may be utilized to reduce ghosting effects in the lenticular images. Further, colors for the base 110 and symbols 120, as well as graduation marks 130, may be selected to provide improved contrast and ease of reading.

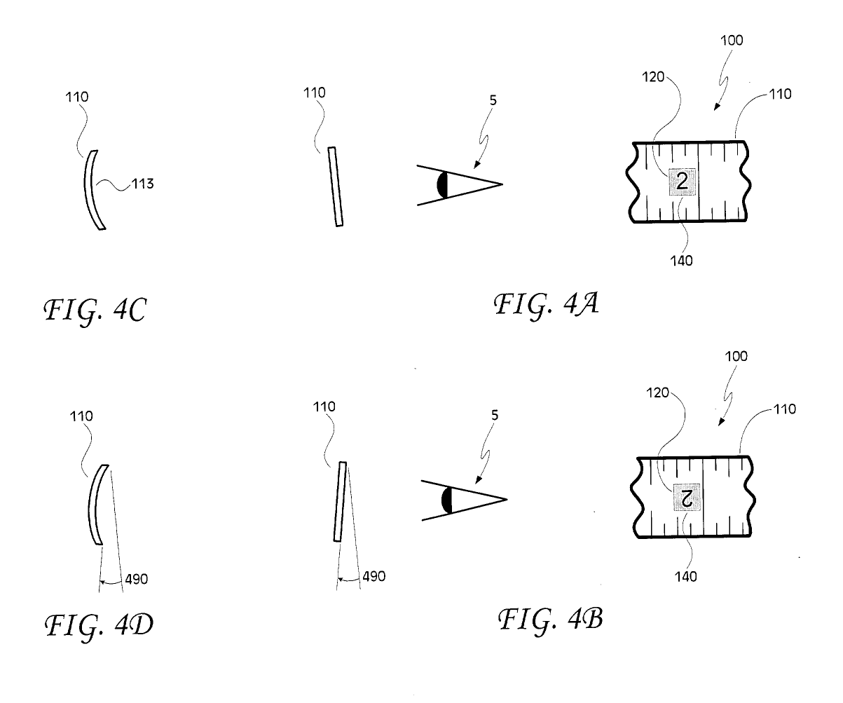

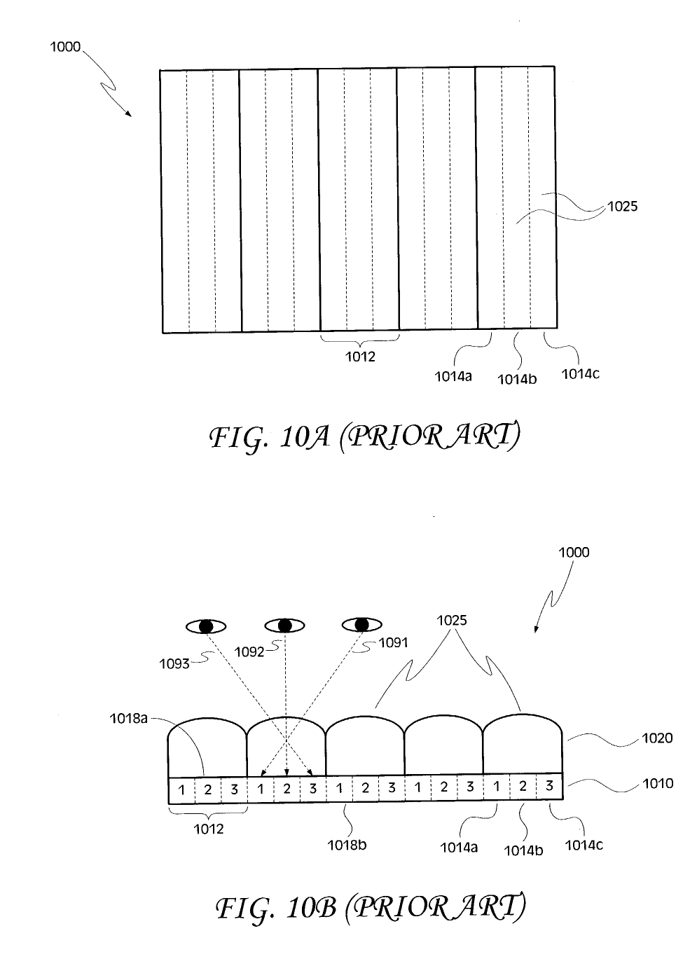

As noted above, the symbols 120 may be altered from one orientation to another in response to movement of the base 110 by the user (or, where the base 110 is stationary, in response to a change in position or viewing angle of the user relative to the base). This is illustrated in FIGS. 4A-4B and 5A-5D for the embodiments wherein the device (or devices) 140, 240, 340 comprises a lenticular device, and a conventional lenticular device is illustrated in FIGS. 10A and 10B. However, it is emphasized here that the disclosed embodiments are not limited to the use of lenticular images.

Referring to FIGS. 10A and 10B, illustrated is an embodiment of a conventional lenticular device 1000 (or a portion of a lenticular device). The lenticular device 1000 comprises an underlying layer 1010 upon which a layer 1020 of lenses 1025 has been formed or otherwise disposed. The layer 1020 of lenses 1025 may be constructed from a clear plastic or other transparent material, whereas the underlying layer 1010 may comprises a transparent material or an opaque material. Each of the lenses 1025 extends longitudinally across the width of the underlying layer 1010. For the embodiment of FIGS. 10A and 10B, the lenticular device 1000 comprises two layers 1010, 1020; however, in another embodiment, the lenticular device 1000 is formed as a single layer or sheet of material.

A region 1012 of underlying layer 1010 that lies underneath each lens 1025 is partitioned into a suitable number of bands, including bands 1014a, 1014b, 1014c (numbered “1”, “2”, and “3”). As will be understood from the description that follows, the number of bands 1014a-c in each region 1012 is generally (although not necessarily) equal to the number of distinct images that the lenticular device 1000 can provide. Within each band 1014a-c of each region 1012, a portion of an image is formed (i.e., an “image band”). For example, the image bands may be formed (e.g., printed) on an upper surface 1018a of the underlying layer 1010 or, if the underlying layer is constructed from a transparent material, the image bands (reverse images) may be formed on a lower surface 1018b of the underlying layer 1010. Also, where the lenticular device is constructed as a single sheet of material, the image bands may be formed on the back side of the lenticular sheet.

The collection of all image bands in the same band of each region 1012 provide one image. For example, the image bands disposed in all bands 1014a (i.e., all bands numbered “1”) comprise a first image, the image bands disposed in all bands 1014b (i.e., all bands numbered “2”) comprises a second image, and the image bands disposed in all bands 1014c (i.e., all bands numbered “3”) comprise a third image. Any suitable number of bands 1014a-c within each region 1012—and, hence, any suitable number of images—may be provided. Thus, each images is made up of a number of spaced-apart image bands, the image bands of one image being separated from one another by image bands associated with the other images.

To view the first image (in bands 1014a), the lenticular device 1000 is viewed from an angle 1091. When the lenticular 1000 is viewed from angle 1091, each of the lenses 1025 focuses light on the first image band (i.e., band 1014a numbered “1”) of each region 1012. The viewer's brain then combines the images bands into a single image, such that the viewer sees only a single image when viewing the lenticular from the angle 1091. Similarly, when viewed from another angle 1092, each lens 1025 focuses light on the second image band (i.e., band 1014b numbered “2”) of each region 1012, and these image bands are combined into a second, single image by the viewer's brain. When viewed from yet another angle 1093, each lens 1025 focuses light on the third image band (i.e., band 1014c numbered “3”) of each region 1012, which images are combined into a third distinct image that can be seen by the viewer. Thus, by movement (e.g., tilting or rotation) of the lenticular device 1000, a number of different images can be selectively presented to the viewer one at a time.

With reference now to FIGS. 4A and 4B, illustrated is an embodiment of operation of the measuring device 100, wherein the measuring device 100 utilizes lenticular imaging. A portion of the measuring device 100 of FIGS. 1A-1B is shown in each of FIGS. 4A and 4B (shown on the right in each of these figures). As described above, the base 110 of measuring device 100 has a number of devices 140 disposed thereon, wherein each device 140 provides one of the symbols 120. In the embodiment of FIGS. 4A-4B, each device 140 comprises a lenticular device. It should be understood that the following embodiment of operation of the measuring device 100 is also applicable to the embodiments of measuring device 100 shown in FIGS. 2A-2B and FIGS. 3A-3B.

Referring to FIG. 4A, the base 110 (shown on the left in side elevation view) is held or maintained in first position relative to a viewer 5. When viewed in this first position, a symbol 120 (i.e., the number “2”) on the measuring device 100 is presented to the viewer in a first orientation. Referring to FIG. 4B, the base 110 has been rotated or tilted through an angle 490 into a second position relative to the viewer 5. When viewed in the second position, the symbol 120 is presented in a second orientation, which in this instance is 180 degrees apart from the first orientation. Essentially, the viewer 5 sees one image (i.e., the first orientation of symbol 120) when viewing the lenticular device 140 (or 240 or 340) from a first angle and sees a second image (i.e., the second orientation of symbol 120) when viewing the lenticular device 140 from a different angle. Thus, in response to movement of the base 110 by the user—or in response to a change in position or viewing angle of the user relative to the base 110, or in response to some other suitable input—the symbols 120 can be altered between the first orientation and the second orientation, as conditions require (e.g., depending upon whether a left-hand read or a right-hand read measurement is being taken).

Note that in FIGS. 4A and 4B, the base 10 is illustrated as having a generally thin, rectangular cross-section (e.g., as may be the case for rules, straight edges, and other measuring sticks). However, it should be understood that the base 110 may be of any other suitable shape or configuration. For example, the base may comprise a flexible tape having a cross-sectional profile that is curved or that is otherwise non-planer in shape (e.g., as may be the case for tape measures). This embodiment is illustrated in FIGS. 4C and 4D in conjunction with FIGS. 4A-4B. Referring to FIG. 4C, the base 110 has a cross-sectional profile 113 that is curved. In FIG. 4C, the base 110 is held or maintained in the first position, wherein the viewer 5 sees the symbol 120 in the first orientation (see FIG. 4A). Referring to FIG. 4D, the base 110 having the curved cross-sectional profile 113 is rotated or tilted through the angle 490 into the second position relative to the viewer 5, wherein the symbol 120 is presented to the viewer in the second orientation (see FIG. 4B).

Turning to FIGS. 5A through 5D, another embodiment of operation of the measuring device 100 is illustrated, wherein the measuring device again utilizes lenticular imaging. A portion of the measuring device 100 of FIGS. 1A-1B is shown in each of FIGS. 5A-5D (shown on the right in each of these figures). As described above, the base 110 of measuring device 100 has a number of devices 140 (e.g., lenticular devices in this embodiment) disposed thereon, wherein each device 140 provides one of the symbols 120. It should be understood that the embodiment of operation of measuring device 100 illustrated by FIGS. 5A-5D is also applicable to the embodiments of measuring device 100 shown in FIGS. 2A-2B and FIGS. 3A-3B. Also, it should be understood that the base 110 may have a curved or otherwise non-planer cross-section, as described above with respect to FIGS. 4C and 4D.

Referring to FIG. 5A, the base 110 (shown on the left in side elevation view) is held or maintained in first position relative to a viewer 5. When viewed in this first position, a symbol 120 (i.e., the number “2”) on the measuring device 100 is presented to the viewer in a first orientation. Referring to FIG. 5B, the base 110 has been rotated or tilted through an angle 591 into a second position relative to the viewer 5. When viewed in the second position, the symbol 120 is presented in a second orientation, which in this instance is 90 degrees apart from the first orientation. Referring to FIG. 5C, the base 110 has been tilted through an angle 592 into a third position and, when the viewer 5 sees the symbol 120 in the third position, the symbol is presented in a third orientation that is 90 degrees from the second orientation (or 180 degrees from the first orientation). Similarly, referring to FIG. 5D, the base 110 has been rotated through an angle 593 into a fourth position. When the viewer 5 observes the symbol 120 in the fourth position, the symbol is presented in a fourth orientation that is 90 degrees from the third orientation (or 270 degrees from the first orientation).

For the embodiment shown in FIGS. 5A-5D, the viewer 5 sees one of four images provided by the lenticular device 140 (or 240 or 340) depending upon the position of the base 110 relative to the viewer 5. The symbol 120 presented by the lenticular device 140 is, therefore, alterable between any one of four orientations (or any one of four distinct images provided by the lenticular device), as selected by the viewer 5 via movement of the base 110 (or a change in position or viewing angle of the user relative to the base 110). Accordingly, the viewer 5 may select one orientation when performing a left-hand read measurement (see FIG. 5A), select another orientation when performing a top-to-bottom measurement (see FIG. 5B), select a different orientation when performing a right-hand read measurement (see FIG. 5C), and select yet another orientation when performing a bottom-to-top measurement (see FIG. 5D). Thus, irrespective of the type of measurement or the measuring conditions, the symbols 120 are always presented right-side up (or at least nearly right-side up) to the viewer 5.

Generally, a hologram comprises a high contrast, fine grain image that has been created on a photographic film or substrate. The holographic image is created using an object light beam that is directed onto the object being captured and a reference light beam. The photographic film records the interference of light bouncing off the object—i.e., light from the object light beam that is being reflected by the object—with the reference light beam. There are a variety of hologram types, and at least some of these holograms are capable of projecting one image when viewing the hologram at a first angle and projecting a different image when viewing the hologram from a second angle. Thus, it should be understood that, where the device 140 (or 240 or 340) is a hologram, such a holographic device may function in a manner similar to that described above with respect to FIGS. 4A-4D and FIGS. 5A-5D (i.e., alternating between one of multiple orientations in response to movement).

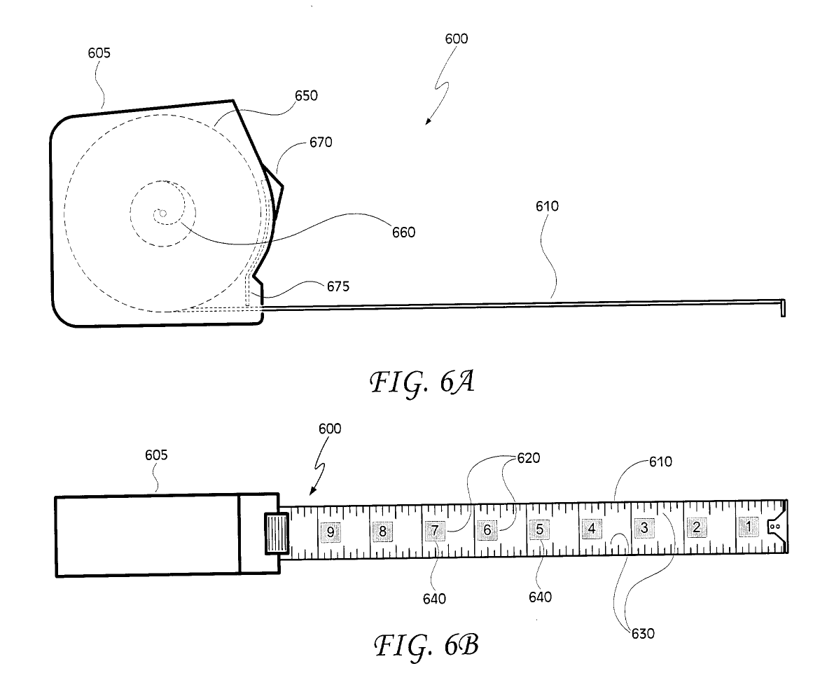

An embodiment of a tape measure 600 having symbols viewable in multiple orientations is illustrated in FIGS. 6A and 6B. A side elevation view of the tape measure 600 is shown in FIG. 6A, and a top view of the tape measure 600 is shown in FIG. 6B. In the embodiment of the tape measure 600 shown in FIGS. 6A-6B, the symbols are provided by devices and/or methods that can alternate between orientations in response to movement. For example, the symbols may be provided by a lenticular device (or devices) or a holographic device (or devices).

Referring to FIGS. 6A and 6B, the tape measure 600 includes a housing 605 and a tape 610 that can be extended from and retracted within the housing 605. A rotatable drum or spindle 650 may be disposed in the housing 605, wherein the tape 610 is windable about the drum 650. Accordingly, when the tape 610 is retracted into the housing 605, the tape 610 is wound around the drum 650, and when the tape 610 is extended from the housing 605, the tape is unwound from the drum. To retract the tape 610 into the housing, a torsion spring 660 (or other suitable spring) may be disposed in the housing 605 and coupled with the drum 650. Torque produced by the torsion spring 660 can rotate the drum 650, thereby causing the tape to be withdrawn into the housing 605 and wound around the drum. Alternatively, rather than a return spring, the tape measure 600 may include a winding arm or lever (not shown in figures) coupled with the drum 650 that allows the user to manually rotate the drum 650 to retract the tape 610 (such tape measures often referred to as “reel tapes” or “long tapes”). Also, the tape measure 600 may includes a brake mechanism 670 having a brake member 675 that, when the brake is actuated by the user, engages the tape 610 to lock the tape in position (e.g., a desired extended position).

The internal structure—i.e., housing 605, rotating drum 650, spring 660, and brake 670—of tape measure 600 is but one example of tape measure construction. The tape measure 600 may utilize any other suitable mechanisms or techniques for extending, retracting, and storing the tape 610 within housing 605. Therefore, it should be understood that the tape measure 600 is not limited to the structure illustrated in FIGS. 6A and 6B and, further, that the tape measure 600 may employ any other suitable mechanisms for extending and retracting the tape 610.

The tape 610 includes a plurality of numbers or other symbols 620, and each of the symbols 620 can be viewed in multiple orientations (e.g., two orientations 180 degrees apart, or four orientations separated by 90 degrees), as described above with respect to FIGS. 1A through 5D. Also disposed on the tape 610 are a plurality of graduation marks 630. Any suitable set of graduation marks may be incorporated in tape measure 600, including graduation marks corresponding to the English system, graduation marks corresponding to the Metric system, as well as graduation marks corresponding to a specialized measurement system (e.g., for roofing, framing, drywalling, etc.). Generally, as noted above, each graduation mark denotes a unit of distance (e.g., ⅛″, 1/16″, 1/32″ for English units and 1 mm or 1 cm for Metric units), and the graduation marks may be formed using any suitable technique (e.g., printing, etching, stamping, and the like).

The symbols 620 may be provided by and/or presented using any suitable device and/or using any suitable method or technology. In one embodiment, as illustrated in FIG. 6B, each of the symbols 620 may be provided by a separate device 640 that has been attached to the tape 610 using any suitable attachment method (e.g., adhesive bonding, welding, thermo-compression bonding, etc.). By way of example, each device 640 may comprise a lenticular device, a hologram, or other device capable of changing orientation of the symbol 620 in response to movement. The tape 610—which may be constructed from metals, plastics, or composite materials—may have a curved cross-sectional profile to provide resistance to bending when the tape 610 is extended from the housing 605 (see FIGS. 4C and 4D above). In some embodiments, the devices 640 (or single device, as noted below) may be adapted to compensate for this curved profile.

In other embodiments, all of the symbols 620 (or at least a portion of them) are provided by a single device (e.g., a lenticular, a hologram, or other device) that is attached to the tape 610, and this single device may be narrower than the tape 610 or have a width nearly the same as that of the tape (see FIGS. 2A-2B and FIGS. 3A-3B, respectively). The graduation marks 630 may, in one embodiment, be printed or formed directly on the tape 610; however, where the width of this single device is substantially equal to the width of the tape, the single device may also provide the graduation marks 630. In yet a further embodiment, the tape 610 itself may comprise a device (e.g., a lenticular device or a holographic device) that provides the symbols 620 (and, perhaps, the graduation marks 630 as well).

For the embodiment of tape measure 600 illustrated in FIGS. 6A and 6B, the desired orientation of the symbols 620 is presented in response to an input from the user, which, in this instance, comprises movement (e.g., tilting or rotation) of the tape 610 (and/or housing 605) or a change in position or viewing angle of the user relative to the tape 610. The symbols 620 may each be alterable between any suitable number of orientations. For example, the symbols 620 may alternate between a first orientation and a second orientation separated by 180 degrees from the first (see FIGS. 4A-4B). Alternatively, by way of further example, the symbols may alternate between four different orientations, wherein each orientation is separated from the other orientations by 90 degrees (see FIGS. 5A-5D). Thus, the symbols 620 may always appear right-side up (or nearly right-side up) to the user and, further, only one orientation may be presented to the user at a time. Conditions that may lead to measurement errors when using the tape measure 600—e.g., symbols that are closely spaced and cluttered together, symbols that are presented upside down, etc.—are, therefore, prevented.

Operation of tape measure 600 is further illustrated in FIG. 7. Use of the tape measure 600 in four different measuring scenarios (labeled 600₀, 600₉₀, 600₁₈₀, and 600₂₇₀) is shown. Although a tape measure 600 having symbols 620 that may be presented in four different orientations is shown in FIG. 7, it should be understood that the tape measure 600 may be capable of presenting symbols 620 in any suitable number of orientations (e.g., two orientations separated by 180 degrees or, alternatively, more than four orientations).

The tape measure denoted by reference numeral 6000 shows the tape measure being used to perform a left-hand read measurement on a rectangular-shaped workpiece 703 (i.e., the tape 610 is attached at left on workpiece 703 and the tape measure pulled to the right to extend the tape). The symbols 620 are presented in a first orientation that is right-side up to the viewer. Referring to reference numeral 600₉₀, the tape measure is shown being used to perform a top-to-bottom measurement on workpiece 703 (i.e., the tape 610 is attached to the top of workpiece 703 and the tape measure pulled downwards to extend the tape). The symbols 620 are presented in a second orientation that is, again, right-side up to the viewer. As illustrated at reference numeral 600₁₈₀, the tape measure is shown being using to perform a right-hand read measurement on workpiece 703 (i.e., the tape 610 is attached at the right on workpiece 703 and the tape measure pulled to the left to extend the tape). The symbols 620 are presented in a third orientation and, as before, the symbols are right-side up to the viewer. Turning to reference numeral 600₂₇₀, the tape measure is shown being used to perform a bottom-to-top measurement on workpiece 703 (i.e., the tape 610 is attached to the bottom of workpiece 703 and the tape measure pulled upwards to extend the tape). The symbols 620 are presented in a fourth orientation that is, once again, right-side up to the viewer.

When taking a measurement, to present the symbols 620 in the desired orientation—e.g., the first, second, third, or fourth orientation, as described above—the user holds the tape 610 (and/or housing 605) in an appropriate position (see FIGS. 5A-5D). When moving the tape 610 (and/or housing 605) by an amount necessary to obtain the desired orientation of the symbols 620, the user can simply rotate the tape 610 (and/or housing 605) until the user sees the symbols in the desired orientation (or, alternatively, the user can change their position or viewing angle relative to the tape 610 until the user sees the desired symbol orientation). In other words, the user does not need to have a priori knowledge of a specific quantity of movement or a specific angular orientation of the tape 610 that is necessary to provide a certain orientation of the symbols 620. Rather, the user can simply rely upon his or her eyes to indicate when the appropriate relative position of the tape 610 (and/or housing 605), as well as the desired symbol orientation, has been achieved.

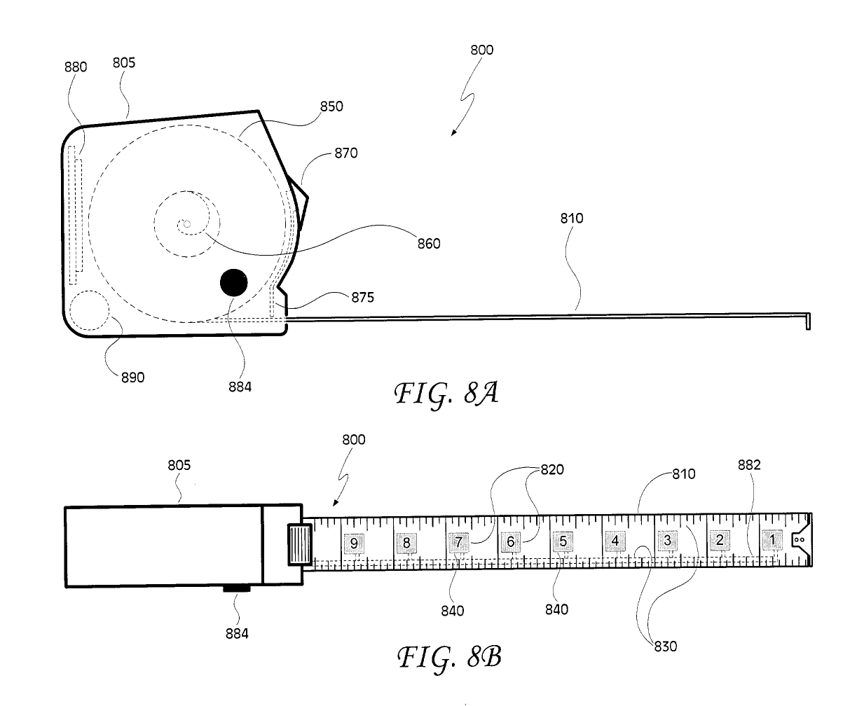

A further embodiment of a tape measure 800 having symbols viewable in multiple orientations is illustrated in FIGS. 8A and 8B. A side elevation view of the tape measure 800 is shown in FIG. 8A, and a top view of the tape measure 800 is shown in FIG. 8B. In the embodiment of the tape measure 800 shown in FIGS. 8A-8B, the symbols are provided by emissive devices (or a single emissive device) that can alternate the symbol orientation in response to an electrical signal. For example, a symbol (or symbols) may be provided by an LED, an OLED, an electroluminescent display, an LCD, or an electrochromic display.

Turning to FIGS. 8A and 8B, the tape measure 800 includes a housing 805 and a tape 810 that can be extended from and retracted within the housing 805. A rotatable drum or spindle 850 may be disposed in the housing 805, wherein the tape 810 can be wound around the drum 850. Therefore, the tape 810 is unwound from the drum 850 during extension, and the tape 810 is wound around the drum 850 during retraction. To retract the tape 810 into the housing, a torsion spring 860 (or other suitable spring) may be disposed in the housing 805 and coupled with the drum 850. Torque generated by torsion spring 860 can rotate the drum 850, which causes the tape to be withdrawn into the housing 805 and wound around the drum. Alternatively, rather than a return spring, the tape measure 800 may include a winding arm or lever (not shown in figures) coupled with the drum 850, and this winding arm allows the user to manually rotate the drum 850 to retract the tape 810. In addition, the tape measure 800 may include a brake mechanism 870 having a brake member 875 that, when the brake is actuated by the user, engages the tape 810 to lock the tape in position (e.g., a desired extended position). It should be understood that the tape measure 800 is not limited to the structure illustrated in FIGS. 8A and 8B and, further, that the tape measure 800 may employ any other suitable mechanism for extending and retracting the tape 810.

The tape 810 includes a plurality of numbers or other symbols 820, and each of the symbols 820 can be presented in multiple orientations (e.g., two orientations 180 degrees apart, or four orientations separated by 90 degrees), as described above with respect to FIGS. 1A through SD (and FIG. 7). Also disposed on the tape 810 are a plurality of graduation marks 830. Any suitable set of graduation marks may be incorporated on tape measure 800, including graduation marks corresponding to the English system, the Metric system, or a specialized measurement system (e.g., for roofing, framing, drywalling, etc.). Generally, as set forth above, each graduation mark denotes a unit of distance (e.g., ⅛″, 1/16″, 1/32″ for English units and 1 mm or 1 cm for Metric units), and the graduation marks may be formed using any suitable technique (e.g., printing, etching, stamping, and the like).

In one embodiment, as illustrated in FIG. 8B, each of the symbols 820 is provided by a separate emissive device 840 that has been attached to the tape 810 using any suitable attachment method (e.g., adhesive bonding, welding, thermo-compression bonding, etc.). The tape 810—which may be constructed from metals, plastics, or composite materials—may have a curved cross-sectional profile to provide resistance to bending when the tape 810 is extended from the housing 805 (see FIGS. 4C and 4D above). In some embodiments, the devices 840 (or single device, as noted below) may be adapted to compensate for this curved profile.

In other embodiments, all of the symbols 820 (or at least a portion of them) are provided by a single emissive device that is attached to the tape 810, and this single device may be narrower than the tape 810 or have a width nearly the same as that of the tape (see FIGS. 2A-2B and FIGS. 3A-3B). The graduation marks 830 may, in one embodiment, be printed or formed directly on the tape 810; however, where the width of this single emissive device is substantially equal to the width of the tape, the single emissive device may also provide the graduation marks 830. In yet a further embodiment, the tape 810 itself may comprise an emissive device that provides both the symbols 820 and graduation marks 830.

As illustrated in FIG. 8A, the tape measure 800 may also include control circuitry 880 to control operation of the emissive devices 840 and a power source 890 (e.g., one or more batteries) to provide power for the control circuitry 880 and emissive devices 840. An electrical conductor 882 extending along the length of the tape 810 may couple each of the emissive device 840 with the control circuitry 880 and/or power source 890. The electrical conductor may be formed on a surface of tape 810 or disposed at an intermediate layer of tape 810. Alternatively, where a single emissive device provides the set of symbols (see FIGS. 2A-2B and 3A-3B), or where the tape 810 itself comprises an emissive device, the electrical conductor 882 may be disposed on or within the single emissive device.

Tape measure 800 may further includes a switch or button 884 coupled with control circuitry 880. In response to actuation of the switch or button 884 by the user, the orientation of the symbols 820 can be altered. Actuation of the switch/button 884 may cause generation of an electrical signal in control circuitry 880 (e.g., a high logic value may be asserted at a pin or a low logic value may be asserted at the pin). To switch between orientations, the user may toggle the switch (e.g., depressing the button once changes orientation) or, alternatively, the user may depress and hold down the button (e.g., one orientation is provided when the button is not depressed and a second orientation is provided when the button is held in the depressed condition). Again, alternative techniques—e.g., voice commands—may be employed to actuate the emissive device or devices.

The desired orientation of the symbols 820 is presented in response to an input from the user, which, for the embodiment of FIGS. 8A and 8B, comprises actuation of a switch or button 884. The symbols 820 are alterable via switch 884 between any suitable number of orientations. For example, the symbols 820 may alternate between a first orientation and a second orientation separated by 180 degrees from the first (see FIGS. 4A-4B), or the symbols 820 alternate between four different orientations separated from one another by 90 degrees (see FIGS. 5A-5D and FIG. 7). Therefore, the symbols 820 may always appear right-side up (or nearly right-side up) to the user and, further, only one orientation may be presented to the user at a time. Accordingly, conditions that may lead to measurement errors when using the tape measure 800 are prevented.

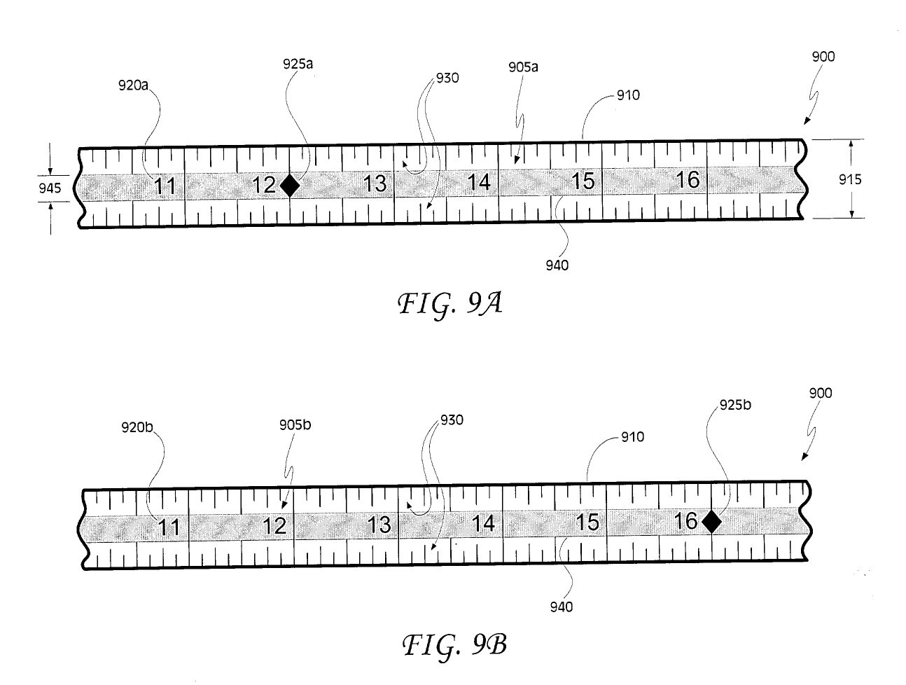

A further embodiment of a measuring device 900 is illustrated in FIGS. 9A and 9B. The measuring device 900 of FIGS. 9A and 9B functions in a manner similar to the other embodiments discloses above in FIGS. 1A through 8B. However, rather than providing symbols alterable between multiple orientations, the measuring device 900 allows the user to select between multiple sets of markings. For example, measuring device 900 may provide a set of markings corresponding to English units and a second set of markings corresponding to Metric units, and the user can selectively present either the English units or the Metric units, as desired. By way of further example, measuring device 900 may provide a set of markings representing a standard measurement system (e.g., English units) and a second set of markings providing a specialized measurement system (e.g., for roofing, drywalling, framing, etc.). Although the above examples provide for only two sets of markings, it should be understood that the measuring device 900 may include any suitable number of marking sets.

Referring to FIGS. 9A and 9B, the measuring device 900 comprises a base 910. Base 910 may comprise a flexible tape (e.g., for a tape measure), which may have a curved cross-sectional profile (see FIGS. 4C and 4D above), or the base 910 may comprise a thin rectangular shaped bar (e.g., a blade for a ruler, straight edge, or other measuring stick), as well as any other suitable structure. Base 910 may be constructed of any suitable material, including metals, plastics, and composite materials. Note that only a portion of the base 910 is shown in each of FIGS. 9A and 9B.

The measuring device 900 includes a first set of markings 905a (shown in FIG. 9A) and a second set of markings 905b (shown in FIG. 9B). The first and second sets of markings 905a, 905b may be provided by any suitable device (or devices), including a lenticular device, a holographic device, or an emissive device, all as previously described. Measuring device 900 may be alterable between presentation of the first set of markings 905a (see FIG. 9A) and presentation of the second set of markings 905b (see FIG. 9B) in response to in input provided by the user, such as movement (e.g., tilting) of the base 910 (or a change in position or viewing angle of the user), an electrical signal (e.g., generated by actuation of a switch/button), or in response to any other suitable input (e.g., a voice command), all as described above.

Also disposed on the base 910 is a plurality of graduation marks 930, as previously described. In the embodiment of FIGS. 9A and 9B, the same graduation marks are used with both of the first and second sets of markings 905a, 905b. However, in other embodiments, each set of markings 905a, 905b may include a distinct set of graduation marks.

In the embodiment of FIGS. 9A-9B, both sets of markings 905a, 905b are provided by a single device 940 (e.g., a lenticular device, a hologram, an emissive device, etc.) having a width 945 less than a width 915 of the base 910. In another embodiment, however, the width of the device 940 is substantially the same as that of base 910, in which case the device 940 may also provide graduation marks 930 or, alternatively, a separate set of graduation marks for each of the sets of markings 905a, 905b, as described above. In a further embodiment, the sets of markings 905a, 905b may be provided by multiple devices (see FIGS. 1A-1B). In yet another embodiment, the base 910 itself may comprise a lenticular device, a holographic device, or an emissive device providing both the first and second sets of markings 905a, 905b.

In the embodiment of FIGS. 9A and 9B, the first set of markings 905a includes a number of symbols 920a (e.g., numbers) and a number of reference marks 925a (only one shown in FIG. 9A). The reference marks 925a are separated by twelve inches, thereby providing the user with a convenient way to measure, mark, and locate items on twelve-inch centers (e.g., for locating wall studs on twelve-inch centers). The second set of markings 905b includes a number of symbols 920b and a number of reference marks 925b (only one shown in FIG. 9B). Reference marks 925b are separated by sixteen inches, which allows the user to measure, mark, and locate items on sixteen-inch centers (e.g., for locating wall studs on sixteen-inch centers).

In FIGS. 9A and 9B, each set of markings 905a, 905b includes a number of symbols 920a, 920b, respectively. However, in another embodiment, the measuring device includes one permanent set of symbols (i.e., always presented in the same orientation) that is used with both the first and second set of markings 905a, 905b, wherein each set of markings 905a, 905b includes only reference marks 925a, 925b. Also, although the figures are shown in black and white, it should be understood that each marking set 905a, 905b may have a different color (e.g., marking set 905a presented in black and marking set 905b presented in red). It should also be understood that FIGS. 9A-9B present but one example of marking sets and, further, that any desired number and types of marking sets may be provided by such a measuring device.

Although the disclosed embodiments have been described above in the context of measuring devices such as rulers and tape measures, it should be understood that the disclosed embodiments may find application to a wide variety of measuring devices. For example, the disclosed embodiments may be applied to devices such as framing squares, combination squares, T-squares, rafter squares, levels, protractors, and combination tools, as well as surveying instruments. Further, although the measuring devices described herein may, in some embodiments, include a lenticular, holographic, or emissive device (or devices) to provide the symbols 120, 620, 820, 920a, 920b, 925a, 925b, it should be understood that such devices (e.g., lenticular, holographic, and/or emissive devices) may also be disposed on a measuring device to provide logos, advertisements, and other visuals.

The foregoing detailed description and accompanying drawings are only illustrative and not restrictive. They have been provided primarily for a clear and comprehensive understanding of the disclosed embodiments and no unnecessary limitations are to be understood therefrom. Numerous additions, deletions, and modifications to the embodiments described herein, as well as alternative arrangements, may be devised by those skilled in the art without departing from the spirit of the disclosed embodiments and the scope of the appended claims.

What is claimed is:

1. A measuring device, comprising:
a base;
a plurality of graduation marks disposed on the base; and
a number of symbols disposed on the base, each of the symbols alterable between a first orientation and a second orientation in response to relative movement of the base.

2. The measuring device of claim 1, wherein at least one of the symbols comprises a number.

3. The measuring device of claim 1, wherein the second orientation is 180 degrees from the first orientation.

4. The measuring device of claim 1, wherein each of the symbols is alterable between the first orientation, the second orientation, a third orientation, and a fourth orientation.

5. The measuring device of claim 4, wherein the first, second, third, and fourth orientations are separated from one another by 90 degrees.

6. The measuring device of claim 1, wherein the relative movement of the base comprises rotation of the base.

7. The measuring device of claim 1, wherein the relative movement of the base comprises a change in position of a user relative to the base.

8. The measuring device of claim 7, wherein the base is stationary.

9. The measuring device of claim 1, wherein the base comprises a flexible tape.

10. The measuring device of claim 9, wherein the flexible tape has a curved cross-sectional profile.

11. The measuring device of claim 1, wherein the base comprises a thin, rectangular shaped bar.

12. The measuring device of claim 1, wherein the base comprises one of a metal, a plastic, and a composite material.

13. The measuring device of claim 1, further comprising a number of lenticular elements, each lenticular element disposed on the base and having one of the symbols formed thereon.

14. The measuring device of claim 1, further comprising a lenticular substrate disposed on the base, the lenticular substrate having the number of symbols formed thereon.

15. The measuring device of claim 14, wherein a width of the lenticular substrate is narrower than a width of the base.

16. The measuring device of claim 14, wherein a width of the lenticular substrate and a width of the base are equal.

17. The measuring device of claim 16, wherein the plurality of graduation marks are formed on the lenticular substrate.

18. The measuring device of claim 1, wherein the base comprises a lenticular material having the symbols and graduation marks formed thereon.

19. The measuring device of claim 1, wherein the number of symbols are formed by holography.

20. The measuring device of claim 19, wherein each of the symbols is formed on a separate substrate element, each separate substrate element disposed on the base.

21. The measuring device of claim 19, wherein the number of symbols is formed on a substrate, the substrate disposed on the base.

22. The measuring device of claim 21, wherein a width of the substrate is narrower than a width of the base.

23. The measuring device of claim 21, wherein a width of the substrate and a width of the base are equal.

24. The measuring device of claim 21, wherein the plurality of graduation marks are formed on the substrate.

25. The measuring device of claim 19, wherein the number of symbols is formed on the base.

26. A tape measure, comprising:
a housing;
a tape disposed within the housing, wherein the tape can be extended from the housing and retracted into the housing; and
a plurality of symbols disposed on the tape;
wherein, when a portion of the tape is extended from the housing, the symbols on the extended portion are alterable between a first orientation and a second orientation in response to relative movement of the extended portion of the tape.

27. The tape measure of claim 26, wherein at least one of the symbols comprises a number.

28. The tape measure of claim 26, wherein the relative movement comprises rotation of the extended portion of the tape.

29. The tape measure of claim 26, wherein the relative movement comprises a change in position of a user relative to the extended portion of the tape.

30. The tape measure of claim 26, further comprising a plurality of graduation marks disposed on the tape.

31. The tape measure of claim 26, further comprising a drum disposed within the housing, the tape windable on the drum.

32. The tape measure of claim 31, further comprising a spring coupled with the drum, the spring to retract the tape into the housing.

33. The tape measure of claim 31, further comprising a winding knob coupled with the drum, the winding knob for manually retracting the tape into the housing.

34. The tape measure of claim 26, wherein the second orientation is 180 degrees from the first orientation.

35. The tape measure of claim 26, wherein the symbols on the extended portion of the tape are alterable between the first orientation, the second orientation, a third orientation, and a fourth orientation in response to movement of the extended portion.

36. The tape measure of claim 35, wherein the first, second, third, and fourth orientations are separated from one another by 90 degrees.

37. The tape measure of claim 26, wherein the tape comprises one of a metal, a plastic, and a composite material.

38. The tape measure of claim 26, wherein the tape has a curved cross-sectional profile.

39. The tape measure of claim 26, further comprising a number of lenticular elements, each lenticular element disposed on the tape and having one of the symbols formed thereon.

40. The tape measure of claim 26, further comprising a lenticular substrate disposed on the tape, the lenticular substrate having the plurality of symbols formed thereon.

41. The tape measure of claim 40, wherein a width of the lenticular substrate is narrower than a width of the tape.

42. The tape measure of claim 40, wherein a width of the lenticular substrate and a width of the tape are equal.

43. The tape measure of claim 42, wherein a plurality of graduation marks are formed on the lenticular substrate.

44. The tape measure of claim 26, wherein the tape comprises a lenticular material having the plurality of symbols formed thereon.

45. The tape measure of claim 26, wherein the plurality of symbols are formed by holography.

46. The tape measure of claim 45, wherein each of the symbols is formed on a separate substrate element, each separate substrate element disposed on the tape.

47. The tape measure of claim 45, wherein the plurality of symbols is formed on a substrate, the substrate disposed on the tape.

48. The tape measure of claim 47, wherein a width of the substrate is narrower than a width of the tape.

49. The tape measure of claim 47, wherein a width of the substrate and a width of the tape are equal.

50. The tape measure of claim 49, wherein a plurality of graduation marks is formed on the substrate.

51. The tape measure of claim 45, wherein the plurality of symbols is formed on the tape.

52. A measuring device, comprising:
a base;
a plurality of graduation marks disposed on the base; and
an emissive device disposed on the base, the emissive device providing a symbol, the emissive device switchable between a first state wherein the symbol is presented in a first orientation and a second state wherein the symbol is presented in a second orientation.

53. The measuring device of claim 52, wherein at least one of the symbols comprises a number.

54. The measuring device of claim 52, wherein the second orientation is 180 degrees from the first orientation.

55. The measuring device of claim 52, wherein the emissive device is switchable between the first state, the second state, a third state wherein the symbol is presented in a third orientation, and a fourth state wherein the symbol is presented in a fourth orientation.

56. The measuring device of claim 55, wherein the first, second, third, and fourth orientations are separated from one another by 90 degrees.

57. The measuring device of claim 52, wherein the base comprises a flexible tape.

58. The measuring device of claim 57, wherein the flexible tape has a curved cross-sectional profile.

59. The measuring device of claim 52, wherein the base comprises a thin, rectangular shaped bar.

60. The measuring device of claim 52, wherein the base comprises one of a metal, a plastic, and a composite material.

61. The measuring device of claim 52, wherein the emissive device provides the plurality of graduation marks.

62. The measuring device of claim 52, further comprising a number of other emissive devices disposed on the base, each of the number of other emissive devices providing a symbol and switchable between the first state wherein the symbol is presented in the first orientation and the second state wherein the symbol is presented in the second orientation.

63. The measuring device of claim 52, wherein the emissive device provides a plurality of other symbols, the plurality of other symbols presented in the first orientation when the emissive device is in the first state and presented in the second orientation when the emissive device is in the second state.

64. The measuring device of claim 52, wherein the base comprises the emissive device.

65. The measuring device of claim 52, wherein the emissive device comprises one of a light emitting diode (LED), an organic LED (OLED), an electroluminescent display, a liquid crystal display (LCD), and an electrochromic display.

66. The measuring device of claim 52, further comprising a power source, the power source electrically coupled with the emissive device.

67. A tape measure, comprising:
a housing;
a tape disposed within the housing, wherein the tape can be extended from the housing and retracted into the housing; and
an emissive device disposed on the tape, the emissive device providing a symbol, the emissive device switchable between a first state wherein the symbol is presented in a first orientation and a second state wherein the symbol is presented in a second orientation.

68. The tape measure of claim 67, wherein at least one of the symbols comprises a number.

69. The tape measure of claim 67, further comprising a plurality of graduation marks disposed on the tape.

70. The tape measure of claim 69, wherein the emissive device provides the plurality of graduation marks.

71. The tape measure of claim 67, further comprising a drum disposed within the housing, the tape windable on the drum.

72. The tape measure of claim 71, further comprising a spring coupled with the drum, the spring to retract the tape into the housing.

73. The tape measure of claim 71, further comprising a winding knob coupled with the drum, the winding knob for manually retracting the tape into the housing.

74. The tape measure of claim 67, wherein the second orientation is 180 degrees from the first orientation.

75. The tape measure of claim 67, wherein the emissive device is switchable between the first state, the second state, a third state wherein the symbol is presented in a third orientation, and a fourth state wherein the symbol is presented in a fourth orientation.

76. The tape measure of claim 75, wherein the first, second, third, and fourth orientations are separated from one another by 90 degrees.

77. The tape measure of claim 67, wherein the tape comprises one of a metal, a plastic, and a composite material.

78. The tape measure of claim 67, wherein the tape has a curved cross-sectional profile.

79. The tape measure of claim 67, further comprising a number of other emissive devices disposed on the tape, each of the number of other emissive devices providing a symbol and switchable between the first state wherein the symbol is presented in the first orientation and the second state wherein the symbol is presented in the second orientation.

80. The tape measure of claim 67, wherein the emissive device provides a plurality of other symbols, the plurality of other symbols presented in the first orientation when the emissive device is in the first state and presented in the second orientation when the emissive device is in the second state.

81. The measuring device of claim 67, wherein the tape comprises the emissive device.

82. The measuring device of claim 67, wherein the emissive device comprises one of a light emitting diode (LED), an organic LED (OLED), an electroluminescent display, a liquid crystal display (LCD), and an electrochromic display.

83. The tape measure of claim 67, further comprising:
a power source disposed within the housing; and
a control circuit disposed within the housing and electrically coupled with the power source.

84. The tape measure of claim 83, further comprising an electrical conductor extending along the tape and coupling the emissive device with the control circuit.

85. A measuring device, comprising:
a base;
a first set of markings disposed on the base, the first set of markings including a number of symbols; and
a second set of markings disposed on the base, the second set of markings including a number of symbols;
wherein the measuring device is alterable between presentation of the first set of markings and presentation of the second set of markings.

86. The measuring device of claim 85, further comprising a set of graduation marks disposed on the base.

87. The measuring device of claim 85, wherein the first set of markings includes a set of graduation marks and the second set of markings includes a set of graduation marks.

88. The measuring device of claim 85, wherein the first set of markings provides an English measurement system and the second set of markings provides a Metric measurement system.

89. The measuring device of claim 85, wherein the first set of markings includes reference marks for measuring twelve inch distances and the second set of markings includes reference marks for measuring sixteen inch distances.

90. The measuring device of claim 85, wherein one of the first and second sets of markings includes reference marks indicating the distance between rows of roofing shingles.

91. The measuring device of claim 85, wherein the measuring device is alterable between presentation of the first set of markings and presentation of the second set of markings by relative movement of the base.

92. The measuring device of claim 91, wherein the relative movement comprises rotation of the base.

93. The measuring device of claim 91, wherein the relative movement comprises a change in position of a user relative to the base.

94. The measuring device of claim 85, wherein the measuring device is alterable between presentation of the first set of markings and presentation of the second set of markings in response to an electrical signal.

95. The measuring device of claim 85, wherein the base comprises a flexible tape.

96. The measuring device of claim 95, wherein the flexible tape has a curved cross-sectional profile.

97. The measuring device of claim 85, wherein the base comprises a thin, rectangular shaped bar.

98. The measuring device of claim 85, wherein the base comprises one of a metal, a plastic, and a composite material.

99. The measuring device of claim 85, further comprising a lenticular substrate disposed on the base, the lenticular substrate having the first and second sets of markings disposed thereon.

100. The measuring device of claim 85, wherein the base comprises a lenticular material having the first and second sets of markings formed thereon.

101. The measuring device of claim 85, wherein the first and second sets of markings are formed on a substrate using holography, the substrate disposed on the base.

102. The measuring device of claim 85, wherein the first and second sets of markings are formed on the base using holography.

103. The measuring device of claim 85, further comprising an emissive device disposed on the base, the emissive device providing the first and second sets of markings.

104. The measuring device of claim 103, the emissive device comprising one of a light emitting diode (LED), an organic LED (OLED), an electroluminescent display, a liquid crystal display (LCD), and an electrochromic display.

105. The measuring device of claim 85, wherein the base comprises an emissive device, the emissive device providing the first and second sets of markings.

106. The measuring device of claim 105, the emissive device comprising one of a light emitting diode (LED), an organic LED (OLED), an electroluminescent display, a liquid crystal display (LCD), and an electrochromic display.
